(19) United States
(12) Patent Application Publication
(10) Pub. No.: US 2011/0017317 A1
(43) Pub. Date: Jan. 27, 2011

(54) PNEUMATIC TIRE VALVE DEVICE AND THE SYSTEM AND THE PROCESS OF SETTING THE TIRE PRESSURE

(76) Inventor: Horst Pritschet, Ingolstadt (DE)

Correspondence Address: Woodard, Emhardt, Moriarty, McNett & Henry LLP, 111 Monument Circle, Suite 3700, Indianapolis, IN, 46204-5137, US

(21) Appl. No.: 12/869,213

(22) Filed: Aug. 26, 2010

Related U.S. Application Data
(63) Continuation of application No. PCT/DE2008/075003, filed on Jul. 16, 2008.

(30) Foreign Application Priority Data
Jul. 17, 2007 (DE) 10 2007 033 625.1

(51) Int. Cl. F16K 15/20

(52) U.S. Cl. 137/223

(57) ABSTRACT

A pneumatic tire valve device is constructed and arranged for attachment to a tire to change the tire pressure. The device includes a tire valve body housing, tire closing valve, and control piston. The housing defines a control piston channel that spans between a pressure pipe intake opening and a bleeding outlet and a tire intake opening that intercepts the control piston channel. The tire closing valve is positioned in the tire intake opening and is operable between an open position wherein air flows into or out of the pneumatic tire and a closed position wherein air is blocked from flowing into or out of the pneumatic tire. The control piston is positioned in the control piston channel and is operable between an idle position wherein air is blocked from flowing out of the bleeding outlet and a tire ventilation position wherein air flows out the tire and the bleeding outlet.

### CROSS-REFERENCE TO RELATED APPLICATION

This application is a continuation of International Application No. PCT/DE2008/075003, filed Jul. 16, 2008, which claims the benefit of German Application No. 10 2007 033 625.1, filed Jul. 17, 2007, the entire disclosure of which are hereby incorporated by reference.

### BACKGROUND

The present invention relates to a pneumatic tire valve device that increases, decreases, or sets the tire pressure of a pneumatic tire of a vehicle as desired by a user of the vehicle.

Pneumatic tires are used on many types of vehicles such as automobiles, motorcycles, trucks, tractors, construction vehicles, mobile homes, agricultural machineries, military vehicles, and the like. Many of these vehicles are designed for use on a paved or asphalt road and on an unpaved road; in other words, the vehicles are designed for operation on various surfaces. The air or tire pressure in pneumatic tires depends on a variety of parameters such as the type of tire, the construction of the tire, the weight of the vehicle, the number of tires, the surface that the vehicle travels over, the planned purpose of the vehicle, and vehicle speed. Below, if the term air or compressed air is used, this includes all of the known and suitable gases that are known and suitable for filling tires. Operation on an asphalt road at a high vehicle speed requires a relatively high tire pressure, in view of the reduction of rolling resistance for the tire. On a relatively soft ground surface, e.g., mud, sand, or snow, a relatively low tire pressure is beneficial as the contact area of the tires increases to improve the traction of the tires on the surface. In particular, for off-road vehicles, military vehicles, and the like, it is desirable to adapt or change the tire pressure to suit the ground or riding surface and purpose of the vehicle. Examples of systems that adapt the tire pressure to the riding surface and purpose of the vehicle include stand alone systems and systems that are integrated with the pneumatic tires. Some of these systems can vary the tire pressure with a compressed air source whether the vehicle is stationary or moving. Such systems include DE 20 220 301 U1 and DE 35 867 27 T2.

Some systems which can adapt or change the tire pressure while a vehicle is moving include a non-rotating compressed air source, such as an air compressor, and a corresponding compressed air line in which compressed air from the air compressor is fed into the pneumatic tires. These systems typically require a pipe or tubing for the pneumatic line to connect the air compressor to the tires to deliver the compressed air to the pneumatic tires. As such, the pneumatic line is positioned over a middle portion of a tire axle that connects to a tire wheel hub. A conduit is fluidly connected from a defined location or point on the pneumatic wheel to the pneumatic line or pipe. Often, tire hubs include planetary gears and bearings which are run in an oil bath or an oil sump for lubrication. To maintain lubrication of the gears and bearings, the locations where the conduit passes through the hub must be sealed with lip seals or shaft seals. If any of these locations or points leak, then compressed air and oil will escape. The oil loss leads to a loss of lubricity and the result may be a failure of the planetary gears and/or bearings. For this reason, the conduits to the tires are kept depressurized with the exception of the operating states that exist for increasing the tire pressure or for reducing the tire pressure. In this respect, DE 35 867 27 T2 uses a compressed air source and a control device by means of which air at a predetermined pressure is fed to valves that are connected to the pneumatic tire. These known valves are designed as diaphragm valves.

The pneumatic tire valve device disclosed herein, i.e., the selected embodiment, includes a tire valve body housing that defines a pressure pipe intake opening and a bleeding outlet. The compressed air pipe is connected to the pressure pipe intake opening to pass air into the pneumatic tire. The pneumatic tire valve device also includes a tire closing valve that is operable in either a closed position or an open position and a control piston that is operable between a resting (idle) position and a tire-venting position. The control piston closes or seals the bleeding outlet in the idle position and releases or uncovers the bleeding outlet in the tire-venting position. Also in the tire-venting position, the control piston maintains the tire closing valve in an open position so that air from the tire can drain through the bleeding outlet.

As mentioned previously, the pneumatic tire valve device disclosed herein includes two separate mechanical parts, a tire closing valve and a control piston. The control piston can open the tire closing valve compulsorily to release air from the pneumatic tire. This constructive system of the pneumatic tire valve device ensures an exact and reliable setting of tire pressure in a pneumatic tire.

The control piston can be operated or configured to operate by many different forms of energy, such as mechanical, electrical, hydraulic, pneumatic or by other energy sources. Preferably, the control piston is operated pneumatically. The control piston is positioned in a control piston channel in the tire valve body housing. The control piston is operable within the control piston channel to allow air to pass from the pressure pipe intake element through the bleeding outlet of the tire valve body housing when the control piston is moved away from the bleeding outlet. The control piston is also operable to stop air from escaping through the tire intake opening of the tire valve body housing when the control piston remains in an idle position in which the control piston covers the bleeding outlet.

In some embodiments, the pneumatic tire valve device includes a non-return valve that engages a tire closing valve bore and an external system (not illustrated) that is configured to push air through the non-return valve and into the tire. The non-return valve also functions to allow air to vent from the tire and the tire closing valve to decrease the tire pressure.

In the illustrated embodiment, the control piston includes a sealing element such as a lip seal that is positioned in a notch or groove of the control piston. The lip seal slopes outward to contact the control piston channel. As such, the lip seal allows air to pass through the control piston channel when the control piston is in the tire-venting position and seals the control piston channel when the control piston is in the idle position.

The configuration of the sealing element or lip seal on the control piston positioned in the control piston channel is advantageous in that negative pressure or suction can be applied via the pressure pipe intake element when the control piston is in the tire-venting position and the tire closing valve is in the open position to allow air to pass from the tire through the tire intake element to vent out the bleeding outlet. In this configuration, the control piston constrains the tire closing valve in the open position and air is drained from the tire through the bleeding outlet.

A tire valve body housing defines an airflow pathway between the pressure pipe intake opening, control piston channel, the bleeding outlet, and the tire intake opening. The control piston channel and the tire intake opening are connected via an activity shank aperture. The control piston is positioned in the control piston channel and the tire closing valve and a tire intake element are positioned in the tire intake opening.

In the illustrated embodiment, the clearance between a lip seal on the control piston and the control piston channel is approximately between about 0.1 mm and about 0.5 mm, and preferably about 0.3 mm. This clearance allows air to pass between the lip seal and the control piston channel.

The control piston includes a conically shaped exterior contact surface which is configured to contact and hold the tire closing valve in the open position to vent air from the tire when the control piston is in the tire-venting position. The conically shaped exterior contact surface forms an angle of approximately 15 to 20 degrees from a vertical reference line.

The tire closing valve includes a tire closing valve base opposite an activity shank and an activity shank end wherein the activity shank is positioned in the activity shank aperture and the tire closing valve base is positioned in the tire intake opening. In the illustrated embodiment, both the tire closing valve base and the activity shank have a cylindrical shape. When the control piston is in the tire-venting position, the activity shank end contacts the contact surface of the control piston. As such, the contact surface of the control piston presses against the activity shank end to maintain or keep the activity shank end positioned in the activity shank aperture to result in an opening between the activity shank end and the activity shank aperture to allow air to pass through the tire intake element.

The tire closing valve includes a tire closing valve sealing ring positioned between the tire closing valve base and the activity shank. In one form, the tire closing valve sealing ring is an elastomeric O-ring.

In the illustrated embodiment a tire closing spring is positioned around the tire closing valve base and against the tire intake element. In the closed position, the tire closing spring is in a compressed configuration against the tire closing valve base to push the activity shank towards the control piston. In the open position, the tire closing spring is released as the tire closing valve is drawn towards the tire intake element. As mentioned above, when the control piston is in the tire-venting position, the contact surface of the control piston presses against the activity shank end and pushes the activity shank end into the activity shank aperture.

In another embodiment, an additional non-return valve (not illustrated) is operationally configured to attach to the tire closing valve to enable manual draining of air from the tire and filling of air into the tire via the tire closing valve. An external system (not illustrated) is configured to push air through the non-return valve and into the tire. The external system may be used if there is a failure in the pneumatic tire valve device such that air cannot be drained from the tire.

In yet another embodiment, a compressor or a control device is connected to the pneumatic tire valve device to set the tire pressure of a pneumatic tire of a vehicle. One example of the control device includes a main valve having an enhanced control block. The control device is connected to a compressed air pipe that connects with the pressure pipe intake element of the pneumatic tire valve device to provide the correct air pressure to the pneumatic tire.

To increase the tire pressure of a pneumatic tire of a vehicle, a user activates the control device so that compressed air streams from the compressed air source to the compressed air intake opening. If the desired tire pressure in the pneumatic tire is established, the compressed air will stream to the compressed air intake opening end. Subsequently, the compressed air pipe is ventilated.

To decrease tire pressure, a negative pressure is applied to the compressed air intake opening to pull the control piston to the tire-venting position. The tire closing valve is in the open position and the bleeding outlet is uncovered as the control piston is moved away from the bleeding outlet. If a desired tire pressure is established, then the control piston returns to the idle position to cover the bleeding outlet and the tire closing valve moves to a closed position.

### BRIEF SUMMARY

A pneumatic tire valve device is constructed and arranged for attachment to a pneumatic tire to increase or decrease the tire pressure. The device includes a tire valve body housing, a tire closing valve, and a control piston. The tire valve body housing defines a control piston channel that spans between a pressure pipe intake opening and a bleeding outlet and a tire intake opening that intercepts the control piston channel. The tire closing valve is positioned in the tire intake opening and is operable between an open position wherein air flows into or out of the pneumatic tire and a closed position wherein air is blocked from flowing into or out of the pneumatic tire. The control piston is positioned in the control piston channel and is operable between an idle position wherein air is blocked from flowing out the bleeding outlet and a tire ventilation position wherein air flows out the tire and the bleeding outlet

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a diagrammatic sectional view of a pneumatic tire valve device according to one embodiment that depicts a first operating state in which a control piston is in an idle position and a tire closing valve is in a closed position.

FIG. 2 is a diagrammatic sectional view of the FIG. 1 pneumatic tire valve device that depicts a second operating state in which the control piston is in an idle position and the tire closing valve is in an open position.

FIG. 3 is a diagrammatic sectional view of the FIG. 1 pneumatic tire valve device that depicts a third operating state in which the control piston is in a tire-venting position and the tire closing valve is in the open position.

FIG. 4 is a perspective view of a tire valve body housing of the FIG. 1 pneumatic tire valve device.

FIG. 5 is a diagrammatic sectional view of a control piston of the FIG. 1 pneumatic tire valve device.

FIG. 6 is a cross-sectional view of the tire closing valve.

FIG. 7 is an exploded perspective diagrammatic view of the FIG. 1 pneumatic tire valve device.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

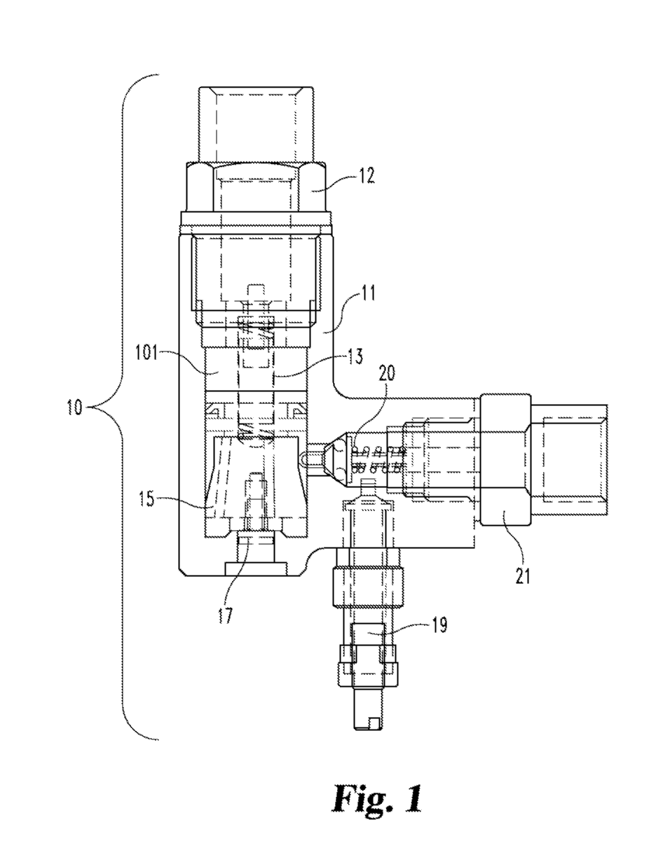

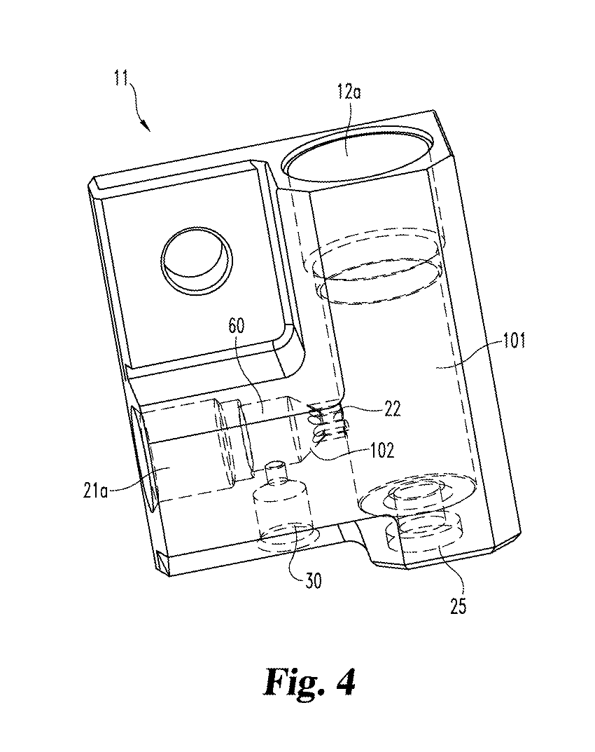

Referring to FIGS. 1, 2, and 3, there is illustrated a pneumatic tire valve device 10. The pneumatic tire valve device 10 includes a tire valve body housing 11 as illustrated in FIG. 4, a pressure pipe intake element 12, a control piston 15, a tire intake element 21, and a tire closing valve 24. In some embodiments, the pneumatic tire valve device 10 includes a non-return valve 19.

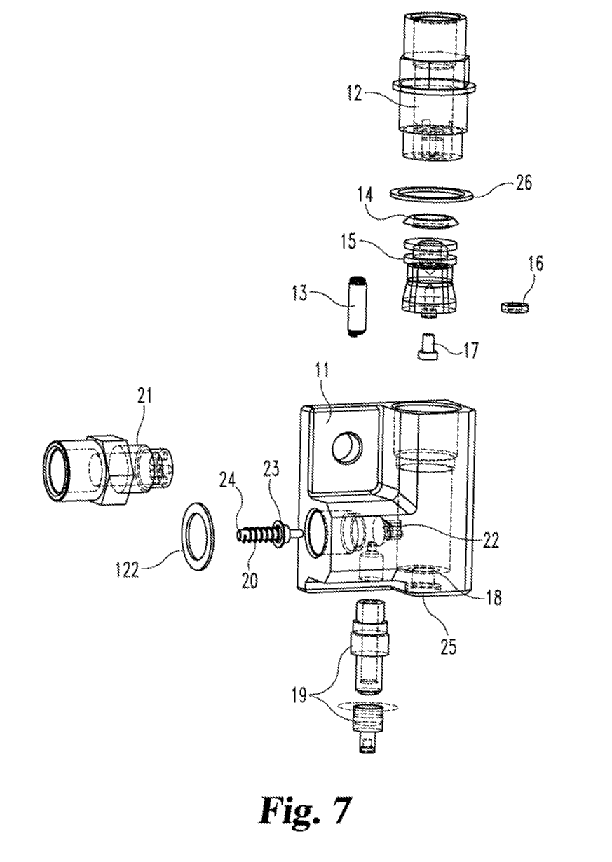

The tire valve body housing 11 (see FIG. 4) defines a control piston channel 101 that spans between a pressure pipe intake opening 12a and a bleeding outlet 25. As shown in FIG. 7, the bleeding outlet 25 extends towards opening 18. The tire valve body housing 11 also defines a tire intake opening 21a that connects with a tire closing valve bore 60 that tapers towards a tire closing valve aperture 102 and an activity shank aperture 22. The activity shank aperture 22 spans between the tire closing valve bore 60 and the control piston channel 101. In the illustrated embodiment, the tire valve body housing 11 also defines a non-return valve bore 30 that intercepts the tire closing valve bore 60.

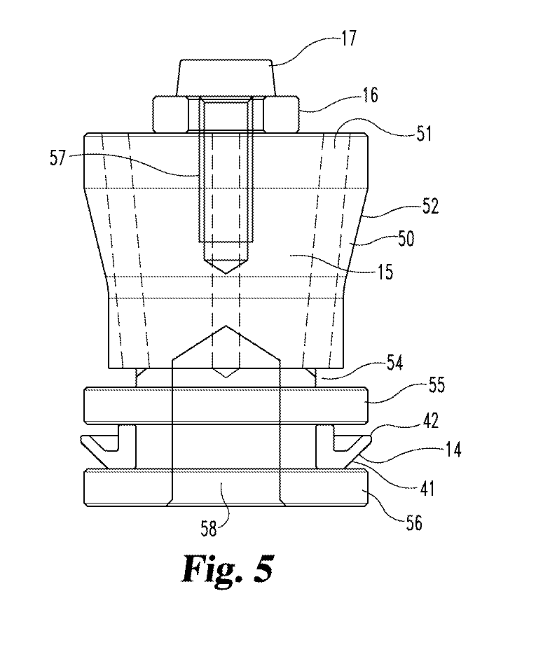

The control piston 15 is inserted into the control piston channel 101 and is moveable within the control piston channel 101. The control piston 15 (see FIG. 5) has a body portion 50 with a conically shaped exterior contact surface 52 that forms an angle of approximately 15 to 20 degrees from a vertical reference line. The body portion 50 includes a plurality of air bores 51 that span the length of the body portion 50 wherein the plurality of air bores 51 are angularly positioned around the circumference of the conically shaped exterior contact surface 52. In one embodiment, the plurality of air bores 51 is 6. The body portion 50 also defines a first interior bore 57 that is sized to receive a screw 17, described in more detail below.

The control piston 15 also defines an air notch 54 that is positioned between the openings of the plurality of air bores 51 and a first ring 55. First ring 55 is circular in shape and sized to contact the control piston channel 101 when the control piston 15 is in the idle position in the control piston channel 101. Control piston 15 also includes a second ring 56 that forms an end opposite the body portion 50. Between the first ring 55 and the second ring 56 is a notch 41 with a lip seal 14 positioned thereon. The lip seal 14 has a circular flared portion 42 that flares outward from the notch 41. In an assembled form, the flared portion 42 of lip seal 14 extends toward the control piston channel 101 when the control piston 15 is in the control piston channel 101. The flared portion 42 of lip seal 14 is sized to allow a clearance of about 0.1 mm to about 0.5 mm, preferably about 0.3 mm, when the control piston 15 is assembled with the control piston channel 101. This clearance allows air to pass between the flared portion 42 of the lip seal 14 and the control piston channel 101.

Control piston 15 also defines a second interior bore 58 that is sized to receive a control piston spring 13, as described below. The second interior bore 58 is open from the second ring 56 towards the body portion 50.

In the illustrated embodiment (see FIG. 5), control piston 15 includes a sealing ring 16 positioned between the head of the screw 17 and the upper surface of body portion 50. When the control piston 15 is assembled with the control piston channel 101 in the idle position, the sealing ring 16 is positioned in the bleeding outlet 25 to seal the bleeding outlet 25.

As mentioned above, the pneumatic tire valve device 10 also includes a pressure pipe intake element 12 that is configured and sized to fit in the pressure pipe intake opening 12a of the control piston channel 101. The pressure pipe intake element 12 is configured to threadably attach to the pressure pipe intake opening 12a. The pressure pipe intake element 12 includes a passageway 120 that is sized to receive a portion of the control piston spring 13. When assembled, a portion of the control piston spring 13 is positioned in passageway 120 of pressure pipe intake element 12 and an opposite end portion of the control piston spring 13 is positioned in the second interior bore 58 of control piston 15.

To add air pressure to a tire, the pressure pipe intake element 12 is connected with a pressure pipe which is connected to a control device (not shown). The control device provides air from a compressed air source (not shown) with a predetermined pressure through the pressure pipe intake opening 12a and the pressure pipe intake element 12. The tire intake element 21 is connected to the inside of a pneumatic tire to deliver the air. As such, the air passes through the pressure pipe intake element 12 and the tire intake element 21 into the tire.

A seal 26 in the form of an O-ring is positioned exteriorly of the pressure pipe intake opening 12a to further seal the pressure pipe intake opening 12a when the pressure pipe intake element 12 is inserted in opening 12a.

As mentioned above, the pneumatic tire valve device 10 in this embodiment includes a non-return valve 19. The non-return valve 19 is placed in the non-return valve bore 30. The non-return valve 19 can be operably connected to an external pressure source to manually increase the air pressure of the pneumatic tire (not shown) or manually decrease the air pressure in the tire. In either operation, the tire closing valve 24 is in the closed position. In one embodiment, the non-return valve 19 is used if an element of the tire valve device 10 fails.

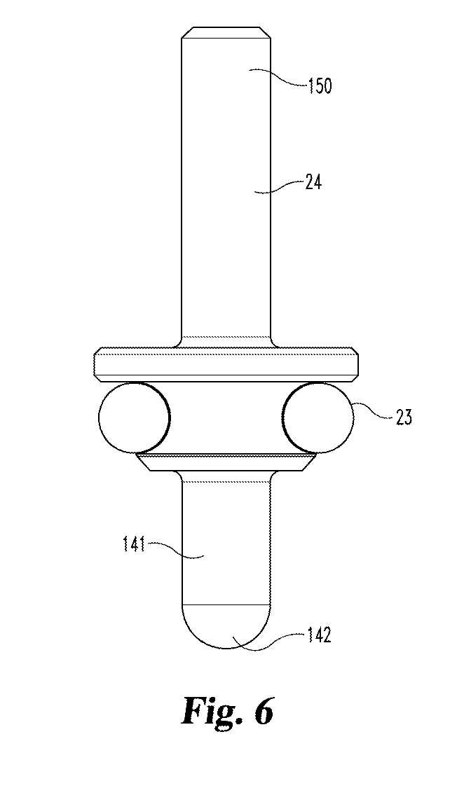

As discussed above, the pneumatic tire valve device 10 also includes a tire closing valve 24 illustrated in FIG. 6. The tire closing valve 24 includes a tire closing valve base 150 opposite an activity shank 141. The activity shank 141 includes an activity shank end 142 that operationally contacts the contact surface 52 of the control piston 15. The tire closing valve 24 also includes a tire closing valve sealing ring 23 positioned between the tire closing valve base 150 and the activity shank 141. The tire closing valve 24 further includes a tire closing valve spring 20 and a tire closing valve sealing ring 23. In an assembled configuration, the activity shank 141 extends through the activity shank aperture 22 of the tire valve body housing 11. The tire closing valve spring 20 and tire closing valve sealing ring 23 are assembled onto the tire closing valve base 150 and a portion of the assembled tire closing valve spring 20 and the tire closing valve base 150 are inserted into the tire intake element 21. When the control piston 15 is in the idle position in the control piston channel 101, the activity shank end 142 does not contact the contact surface 52 of the control piston 15. However, when the control piston 15 is in the tire-venting position in the control piston channel 101, the contact surface 52 of the control piston 15 presses against the activity shank end 142 to move the tire closing valve 24 towards the tire intake element 21 and push the tire closing valve sealing ring 23 away from the tire closing valve base 102 thereby allowing airflow through an activity shank aperture 22.

The pneumatic tire valve device 10 also includes a tire intake element 21 that is configured to attach to the pneumatic tire and allow the passage of air into and out of the tire. A tire intake seal 122 in the form of an O-ring is positioned between the tire intake element 21 and the tire valve body housing 11 to keep air from leaking out of the tire valve body housing 11.

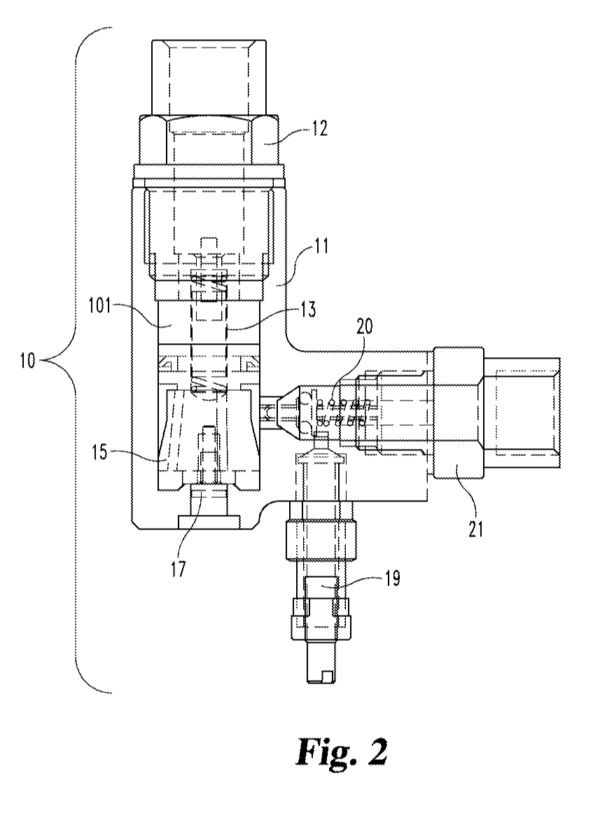

A description of the operation of the pneumatic tire valve device 10 follows. FIG. 1 illustrates the pneumatic tire valve device 10 according to one embodiment that depicts a first operating state in which the control piston 15 is in an idle position and the tire closing valve 24 is in a closed position. To increase the tire pressure of a pneumatic tire, an air pipe is attached to the pressure pipe intake element 12. A control device (not shown) operates a compressed air source (not shown) that is attached to the air pipe to deliver compressed air thereto. The compressed air streams between the flared portion 42 of lip seal 14 and the sidewalls of the control piston channel 101 to push the tire closing valve 24 towards the tire intake element 21 and compress the tire closing valve spring 20. Correspondingly, the tire closing valve sealing ring 23 moves away from the tire closing valve aperture 102 to allow air to pass into the tire intake element 21 from the pressure pipe intake element 12. The tire closing valve 24 is now in the open position and the control piston 15 remains in the idle position as illustrated in FIG. 2.

When the desired tire pressure is reached, the influx of compressed air will be disconnected by a ventilation valve (not shown) on the control device and the air pressure in pressure pipe intake opening will decrease. As such, the tire closing valve 24 is then pushed back into the closed position by releasing the compressed tire closing valve spring 20. In the closed position, the tire closing valve sealing ring 23 returns to the tire closing valve aperture 102 as illustrated in FIG. 1. Beneficially, the pressure in the pneumatic tire can be set exactly with this embodiment.

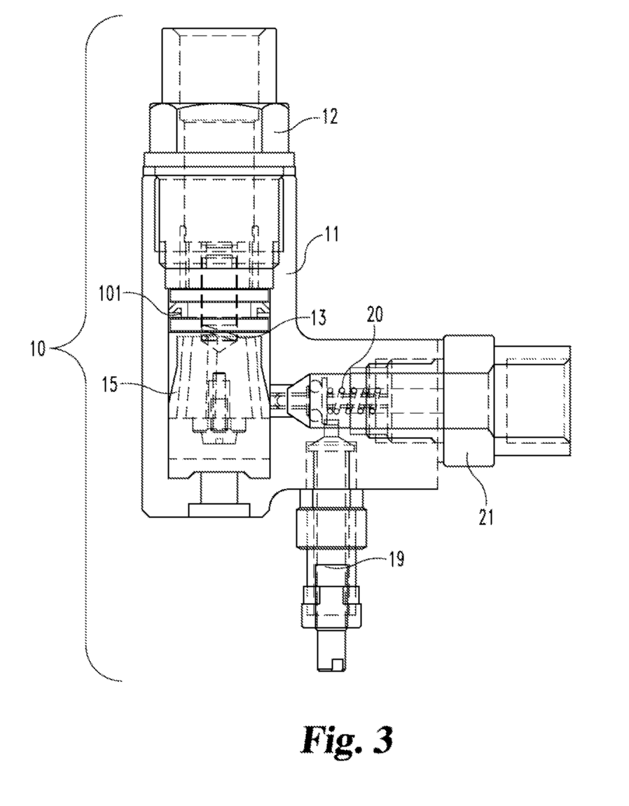

To drain air from the pneumatic tire, negative pressure is applied at the pressure pipe intake opening 12a. The negative pressure causes the control piston 15 to move from the idle position to the tire-venting position as illustrated in FIG. 3. The activity shank end 142 of the activity shank 141 of the tire closing valve 24 contacts the contact area 52 of the control piston 15 so that the tire closing valve 24 is pushed in an open position. Moreover, since the control piston 15 has moved towards the pressure pipe intake element 12, the bleeding outlet 25 is uncovered and a control piston spring 53 is compressed. The compressed air from the pneumatic tire can escape through the activity shank aperture 22, the tire closing valve aperture 102, and the tire intake opening 21a to vent. Compressed air can also escape through the plurality of air bores 51 and the air notch 54 of the control piston 15.

When the desired tire pressure is reached, a corresponding valve in the control device (not shown) closes to stop the negative air pressure at the pressure pipe intake opening 12a. As a result, the control piston 15 returns to the idle position as the release of the control piston spring 53 pushes the control piston 15 to the bleeding outlet 25. The contact area 52 of the control piston 15 moves away from the activity shank end 142. As such, the tire closing valve spring 20 is released and the tire closing valve 24 moves to the closed position wherein the tire closing valve sealing ring 23 is positioned in the tire closing valve aperture 102.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A pneumatic tire valve device constructed and arranged for attachment to a pneumatic tire to increase or decrease tire pressure in the pneumatic tire, the pneumatic tire valve device comprising:
a tire valve body housing defining a control piston channel that spans between a pressure pipe intake opening and a bleeding outlet, the tire valve body housing further defining a tire intake opening that intercepts the control piston channel;
a tire closing valve positioned in the tire intake opening, the tire closing valve is operable between an open position wherein air flows into or out of the pneumatic tire and a closed position wherein air is blocked from flowing into or out of the pneumatic tire; and
a control piston positioned in the control piston channel, the control piston is operable between an idle position wherein air is blocked from flowing out of the bleeding outlet and a tire ventilation position wherein air flows from the pneumatic tire and out the bleeding outlet.
